(19) United States
(12) Patent Application Publication
(10) Pub. No.: US 2013/0115586 A1
(43) Pub. Date: May 9, 2013

(54) FEEDBACK METHODS AND SYSTEMS

(71) Applicants: Shawn R. Cornally, Iowa City, IA (US); Vikram A. Patel, Iowa City, IA (US)

(72) Inventors: Shawn R. Cornally, Iowa City, IA (US); Vikram A. Patel, Iowa City, IA (US)

(21) Appl. No.: 13/670,857

(22) Filed: Nov. 7, 2012

Related U.S. Application Data
(60) Provisional application No. 61/556,572, filed on Nov. 7, 2011.

(51) Int. Cl. G09B 7/00

(52) U.S. Cl. 434/362

(57) ABSTRACT

The present invention relates to methods and system for providing threaded feedback, in the form of a two way conversation between a teacher and a student. In one method, conversation data about a topic inputted by a first authorized user is received and that conversation data is transmitted to a second authorized user for display. In another method, conversation data about a topic inputted by a first authorized user is received from a central server and additional conversation data about the topic inputted by a second authorized user is transmitted to the central server. Systems to carry out these methods are also disclosed. The first and second authorized users include a teacher and/or a student. The conversation data includes rich media, and wherein the topics of conversation or feedback include at least educational targets or attainment of educational targets.

### FIELD OF THE INVENTION

This invention relates to a system and a method of online communication among students and teachers with other interested stakeholders also able to participate. The invention also relates to a system and a method for tracking student progress on assigned learning targets.

### BACKGROUND OF THE INVENTION

Though online systems for tracking student progress have existed for some time, the focus of these systems has been on quantitative grades as opposed to narrative feedback and discussions centered on student performance. Systems that allow space for teachers to leave feedback do not allow for students to reply to the teacher provided feedback and also do not allow for interested third parties (e.g. parents, administrators, etc.) to join the discussions regarding feedback from teachers. These systems also do not allow the inclusion of rich media (e.g. hyperlinks, uploaded files, webcam pictures, video, audio, etc.) into the conversation.

Existing online discussion systems lack the focus on the student-teacher communication and lack the ability to restrict access to discussion threads based on educational target and attainment of those educational targets.

### SUMMARY OF THE INVENTION

The present invention relates to methods and system for providing threaded feedback, in the form of a two way conversation between a teacher and a student. In one method, conversation data about a topic inputted by a first authorized user is received and that conversation data is transmitted to a second authorized user for display. In another method, conversation data about a topic inputted by a first authorized user is received from a central server and additional conversation data about the topic inputted by a second authorized user is transmitted to the central server. Systems to carry out these methods are also disclosed. The first and second authorized users include a teacher and/or a student. The conversation data includes rich media, and wherein the topics of conversation or feedback include at least educational targets or attainment of educational targets.

### BRIEF DESCRIPTION OF THE DRAWINGS

In the drawings:

FIG. 1 shows the logical flow of the user experience in the present invention.

FIG. 2 shows a display of a the teacher view of feedback page in which conversation data is displayed, as well as a control panel for managing the conversation data and identity information.

FIG. 3 shows a display of the feedback page for other authorized users in which conversation data is displayed, as well as a control panel for managing the conversation data and identity information.

FIG. 4 shows a display of a conversation window on a feedback page.

FIG. 5 shows a display of an email notification sent to a user after feedback has been posted.

FIG. 6 shows a display of a page where educational targets, attainment of educational targets or assignments are assigned to students or recorded for students.

### DETAILED DESCRIPTION

The methods and systems of the present invention pertain to the student-teacher interaction in an educational setting. And are focused on providing students and teachers with the ability to discuss educational targets for the student and attainment of those educational targets. The methods and systems also are useful for other authorized users to interact with students and teachers.

The present invention is utilized in an educational setting, where educational setting means instruction in a subject is being given by a teacher to a student. The instruction may be face-to-face (e.g. at a school), or at a distance. Distance instruction may include communications between the teacher and student including audio (e.g. phone or VOIP), video (e.g. video conferencing or video chatting), graphical (e.g. slide presentation), text (e.g. email or postal letter) and combinations thereof. The instruction may include real time interaction between the teacher and student (e.g. video conferencing) or delayed interaction (e.g. a correspondence course). Any subject matter may be included in the educational setting.

The present invention relates to topics of discussion between authorized users. Preferred topics include educational targets and attainment of those educational targets by the student. An educational target is one or more parts of a course of study to be mastered by the student; that is, something to be learned by the student Normally, each class or course of study is a collection of education targets that represent a progression from foundational ideas and concepts through extending those ideas and concepts followed by application of those ideas and concepts to problem solving. An educational target may be as broad as a traditional high school subject (e.g. trigonometry) or as narrow as a particular concept within the subject (e.g. the relationship of sine to cosine).

Attainment is the demonstration by the student of mastery of an educational target. Demonstration of mastery is usually in the form of an exam, test, quiz, homework, or in class assignment, such as an oral exam, a written essay test or an online multiple choice quiz. Attainment also includes those situations in which a student demonstrates a failure to master the educational target.

The teacher and student roles are relative meaning that the teacher may later be the student and vice versa. Rather, the teacher generally leads the instruction while the student generally is the recipient of the instruction. While used in the singular, it is contemplated that both teacher and student includes a group of people acting in the teacher role and a group of people acting in the student role. So, there can be a single teacher instructing a group of students or a group of teachers instructing a single student, along with all the variations in between. In addition to the student teacher interaction, a group of students discuss an educational target of attainment. Likewise, a group of teachers may discuss educational targets or attainment.

In addition to teachers and students, other authorized users may make use of the methods and systems of the present invention. For example, parents and administrators may also be authorized user. Parents include any person outside of the educational setting that takes responsibility or an interest in a student's performance in the educational setting. Typically, parents would include biological parents, guardians, etc., but also include bosses or superiors for those educational settings related to a student's employment or career. Administrators include any person in the educational setting that takes responsibility or an interest in a teacher's performance in the educational setting or take part in running the operations of the educational setting. Typically, administrators include department chairs, deans, provosts, principals, and the like.

In addition, authorized users may be partitioned according to their status within the educational setting. For example, students may be portioned by grade level (e.g. all freshman), class subject matter (e.g. all calculus students), assignment (e.g. all student writing an essay on Moby Dick), attainment status (e.g. mastery of iambic pentameter), campus location (e.g. all students in a building), and combinations thereof. Likewise, other authorized users may be portioned in similar ways, e.g. all parents of freshman.

Topics may also include anything that is of common interest to the group of authorized users or used to portion users into a particular group. For example, topics may also include grades received by students from teachers, such as letter grades or percentile grades.

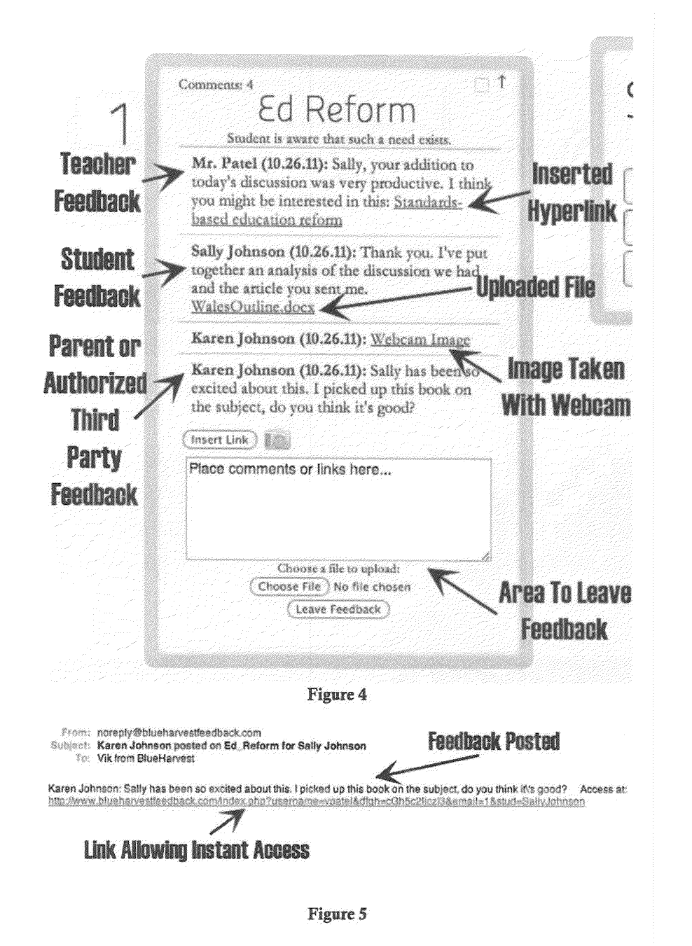

The present invention relates to conversation data to be communicated between student and teacher or among the authorized users. Conversation data includes rich media to be shared between the authorized users. Rich media include audio, video, graphics, photos, narrative text, etc. Conversation data preferably relates to a topic, as discussed above. FIG. 4 shows an example of a conversation data displayed to an authorized user.

In addition, conversation data includes notifications that new conversation relevant to the authorized user has been inputted by another user. Such notifications include messages send to the preferred contact method, as selected by the user. For example, a student may wish to receive a text message each time a teacher provides feedback.

In addition, conversation data (including notifications) includes hyperlinks to rich media, where the rich media was previously included in the conversation data or the rich media is to be incorporated in the conversation data. For example, as discussed below, the conversation data may be sent from a central server to a display. Instead of transmitting a whole video file, a link to the video file may be transmitted to the display, e.g. in the conversation window, as seen in FIG. 4 or in an email message, as seen in FIG. 5. Similarly, a link to a new video not previously included in conversation on a topic may be sent so as to then include the new video in conversation data.

Conversation data is threaded by topic so that only information on a particular topic is gathered together. In this manner, a parent and teacher can discuss in one conversation a particular student's attainment of an educational target.

Moreover, access to threaded conversation data is controlled so that only the relevant users can view and add to the conversation data. In this manner, the level of privacy for a discussion can be set for each discussion. For example, a teacher can give feedback to a student on that student's performance on a quiz without the other students' knowledge. On the other hand, a teacher may open a discussion to all of the parents (but not the students) about behavior problems in the class room. In another example, the teacher may give feedback or start a discussion with those students who did not attain the desired educational target; that is, all students who score in the bottom half of the class on a test.

In order to control access to conversation data, identifying information may also be utilized such the name, ID number, login name, password, contact information (e.g. phone number or email address), etc. of the authorized user.

In a first embodiment, the feedback methods of the present invention including receiving conversation data about a topic from one authorized user at a centralized server. And from the central server, transmitting that inputted conversation data to one or more authorized users for display. The method also includes the ability to receive additional conversation data from other authorized users and transmitting such additional conversation data to authorized users for display. The various conversation data on a topic are associated together to permit a threaded display of the conversation data. Topics for conversation data include an educational target or attainment of an educational target. Typically, the receiving and transmitting steps are carried with the use of a central server.

Associating together conversation data means being able to identify and/or track disparate pieces of data as being related to the same topic. This may be done supplying additional information to the pieces of conversation data; that is, tagging the pieces of conversation data with an identifier. This may also be done by storing the conversation data in a database in a manner that connects the disparate pieces of conversation data together based on topic.

In a second embodiment, the feedback method also includes transmitting conversation data about a topic from a first authorized user to a central server. Receiving from a central server additional conversation data about the topic provided by a second authorized user. The method also includes transmitting additional conversation data to the central server about the topic by the first authorized user. As above, the topic relates to educational targets or attainment of educational targets.

In a third embodiment, the feedback system comprises one or more processors, memory and one or more programs. The program is stored in memory and is executed on the processors. The program includes instructions for carrying out various steps. For example, the program includes instructions for receiving conversation data about a topic from one authorized user. The program also includes instructions for transmitting that received conversation data to one or more authorized users for display. The program also includes instructions for storing the conversation data in a manner that permits retrieval of the conversation data based on topic. As above, the topic relates to educational targets or attainment of educational targets.

In a fourth embodiment, the program of the feedback system includes instructions for transmitting conversation data about a topic from one authorized user to a central server. The program also includes instructions for receiving additional conversation data from a central server for display, where the additional conversation data is supplied by a second authorized user. As above, the topic relates to educational targets or attainment of educational targets.

A central server is a general purpose or purpose built computer including one or more processors, memory and preferably storage whose purpose is to act as a centralized repository for conversation data. Similarly, a display is a general purpose or purpose built computer including one or more processors, memory and preferably storage whose purpose is to display conversation data to the authorized users. The central server, the display and their component parts may be implemented in physical hardware, virtualized hardware or combinations thereof. Also, the central server and the display may be located on the same physical hardware or the same virtualized hardware, however, it is usually preferred that the central server be located remotely from the display; that is, on different physical or virtualized hardware from the display. Any client-server model is suitable for use in the present methods and systems, with a webserver/browser combination being preferred.

The central server functionality is focused on receiving conversation data from an authorized user, storing that conversation data, usually in a database, and then transmitting conversation data to users, who can then display the conversation data. The central server is also focused insuring that the conversation data is only accessed by those users authorized to view or receive that particular conversation data. For example, the central server can control access based on identity of the authorized user, the group to which the authorized user belongs, the topic of the discussion, or the like.

The display functionality is focused on taking input from an authorized user and transmitting that inputted conversation data to a central server. The display also receives information from the central server and provides it to the authorized user for consumption. Therefore, the display may include hardware and/or software to give the authorized user access to the conversation data. For example, the display may include a screen upon which text or video may be viewed by the user. Or the display may include a speaker or audio jack through which a user may listen to audio. In the alternative, the display may only provide a link to the conversation data, and the conversation data primarily reside on the central server until requested by the user.

Transmitting and receiving information, whether conversation data or not, may be accomplished through any variety of protocols. For example, TCP/IP, SSL, FTP, etc. protocols may be used. In one preferred embodiment, a protocol that permits the transmission and receipt of encrypted data is utilized. Further, a variety of formats may be used to transmit and receive conversation data and other data, such as http, https, email, text message, chat, video chat, phone call, voice mail, webpage, etc. The protocols and formats may be used in any combination to provide the desired functionality. In one preferred embodiment, a webserver is used to receive and transmit conversation data from browsers utilized by authorized users. The webserver functionality may be combined with a database.

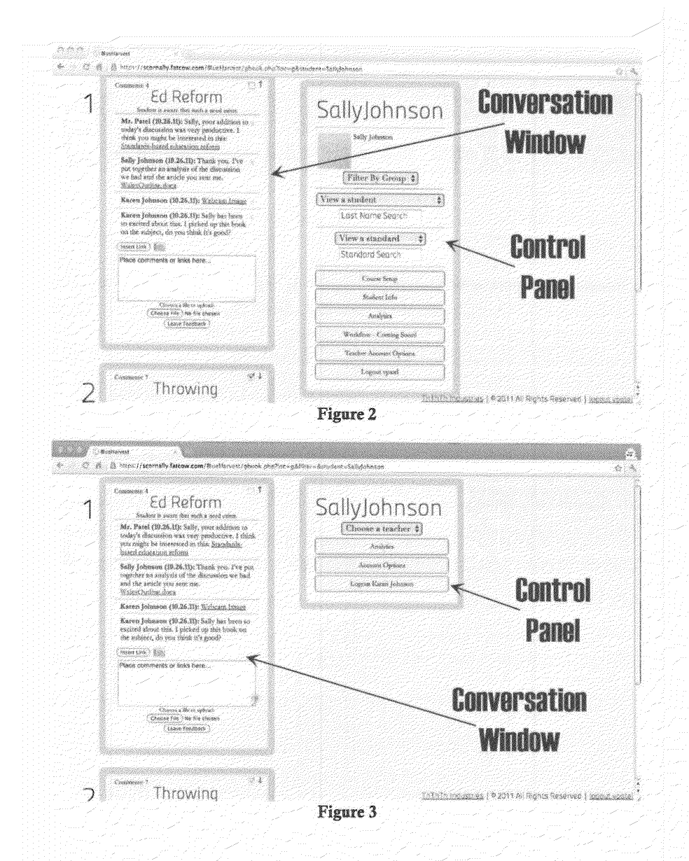

In a preferred embodiment, the methods and systems permit the display of conversation data to be selectively displayed by the user. For example, a teacher could filter all conversation to include only conversation data on a particular student, a particular educational target or an educational attainment. As seen in FIG. 2, this may be done through the use of a control panel. In the alternative, a student could filter his/her conversation data by subject matter (e.g. algebra) or assignment (e.g. mid term exam), as seen in FIG. 3.

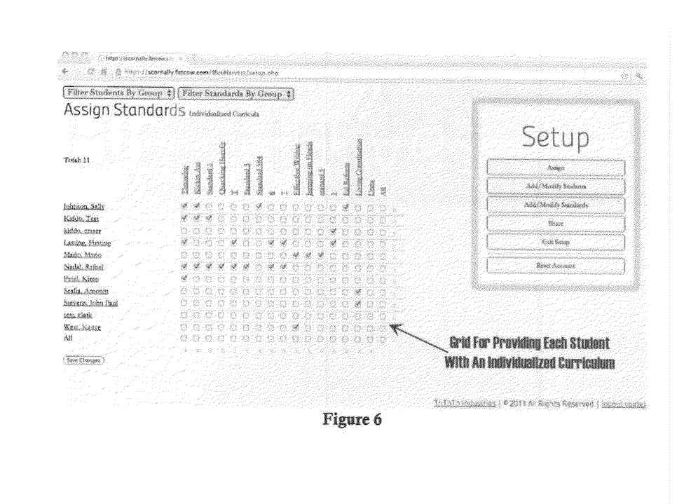

In additional to input and/or display of conversation data, the display may also include functionality for managing identifying information. For example, teachers, administrators, or computer administrators may input information about students, educational targets, educational attainment, login names, passwords, contact information, etc. in order permit securing of conversation data. Again, this may be done through a control panel, as seen in FIG. 2. FIG. 6 shows an example of how educational targets can be customized to provide each student with an individualized curriculum.

In another embodiment, the conversation data is persistent meaning that the back-and-forth between the authorized users may be stored for later retrieval, whether it is retrieved the next hour, the next day, the next week, the next month, the next year, etc.

In another embodiment, the methods and systems include a gradebook. The gradebook allows the teacher to record the progress of a student over the length of the class or grade. For example, the teacher may record letter grade on assignments, quizzes and exams in the gradebook. The teacher may also record attainment of educational targets in the gradebook. Preferably, the information in the gradebook is linked to the conversation data. For example, a failing grade on a test in the gradebook provides a link to the conversation data between the teacher and student discussing the student's performance, etc. A grid system similar to the one shown in FIG. 6 (for individualized curricula) could also be utilized to keep track of educational attainment.

In another embodiment, the feedback systems comprises one or more software modules for receiving, displaying and storing rich media conversations for a group including a student, one or more teachers, and optionally third parties regarding the student's attainment of educational targets. The conversations generally take the form of feedback from the student to the teacher about a given assignment, feedback from a teacher about a student's progress, and/or feedback from parents about an assignment, etc. The feedback may include rich media. Beside information strictly focused on a student's educational attainment, other information may be communicated through the methods and systems and should be included in the definition of feedback. For example, administrative announcements (e.g. cafeteria menus and extra curricula activities) could be passed to all members of the educational community.

The systems preferably provide access control functionality to enable or disable access to student identity information, to educational target information, to particular conversations, etc. The access control functionality may be by user type (e.g. student, teacher or third-party), or other criteria. Furthermore, the system can be made to comply with laws, rules and regulations concerning privacy of student information.

The systems preferably provide database functionality for storing student identity information, for storing educational target information, for storing conversations and associated rich media, etc. This functionality may be implemented in one or more databases, with appropriate linking of databases to connect student identity information with educational targets and conversations about those students and their educational targets. In addition, the database functionality may include the ability to track grades for assignments, tests, courses, etc.

The systems preferably provide user interface functionality for interacting with access control functionality so that permissions may be changed as needed.

The systems preferably provide user interface functionality for interacting with the database functionality so that student information, course information, grade information, educational target information may be changed or linked. In one example, a matrix of educational targets and students may be used to provide an individualized curriculum for students, as seen in FIG. 6. Furthermore, groups of student may be created such as by course (e.g. Algebra I), grade (e.g. third grade), or previous educational attainment (e.g. those who have not mastered multiplication tables).

Furthermore, the systems preferably provide user interface functionality for carrying on and managing the conversations. The conversation user interface includes a control panel and a conversation window, as seen in FIGS. 2 and 3. The control panel is set by the access control level of a given participant; that is, a teacher control panel may differ from the student control panel which may differ from the parent control panel.

The teacher control panel, as seen in FIG. 2, will permit filtering of conversations by student, student group or educational target, either through a search feature or a drop down list. The teacher control panel will also permit interaction with the database functionality such as adding identifying information such as student information, changing group membership, changing educational targets for a group, etc. The teacher user interface may also provide access to summary information (e.g. analytics) about a student or group and their performance over time or with respect to other students. This feature would be a useful addition to any gradebook functionality.

The student control panel, as seen in FIG. 3, will permit filtering of conversation by educational target and/or teacher, as well as access to summary information about the student's performance over time or in comparison to other students.

The third party control panel will permit filtering of conversation by student, teacher and/or educational target, as well as access to summary information about a student's or teacher's performance over time or in comparison to other students or teachers.

The conversation user interface also includes a conversation window, as seen in detail in FIG. 4. The conversation window is typically the same for all users and is typically limited to a single student at a time. The conversation window provides a chronological listing of prior feedback identified by the person giving the feedback and the time of the feedback. The chronological listing also includes the substance of the feedback including links to any rich media that may be included in the feedback. The conversation window further includes an area to leave feedback, as well as options for including rich media or links to rich media.

In addition, group feedback functionality may be included in the system through the conversation window or other mechanism. In this manner, a teacher could provide the same feedback to all students (or parents of students) in a given course or grade or to all students who did not attain a given education target. Moreover, the group feedback functionality may include mass, but individualized, feedback to students or parents. For example, the teacher could notify students of their grades on an assignment, test or for the course.

The system further includes notification functionality such that a user receives a notification when feedback is submitted by another user, as seen in FIG. 5. The notification functionality may include an instant message, a text message, an email message or a phone message. The user may select which type of notification they wish to receive and how often they wish to receive notifications (e.g. for every piece of feedback or in a digest of all the feedback in a given day). In addition to alerting the user that feedback has been provided, the notification may include the feedback directly and/or a link to the feedback so that the feedback may be viewed in context.

While primarily designed for teachers and parents to interact with students and each other, the system also provides the ability for administrators to oversee and interact with a teacher, a group of teachers, a parent or a group of parents, a student or a group of students. The system also provides the ability for a group of parents to interact with each other.

The system is implemented in an appropriately programmed general purpose computer. In a preferred embodiment, the user interface functionality of the system is implemented in web browser and the other functionalities of the system are implemented on a webserver.

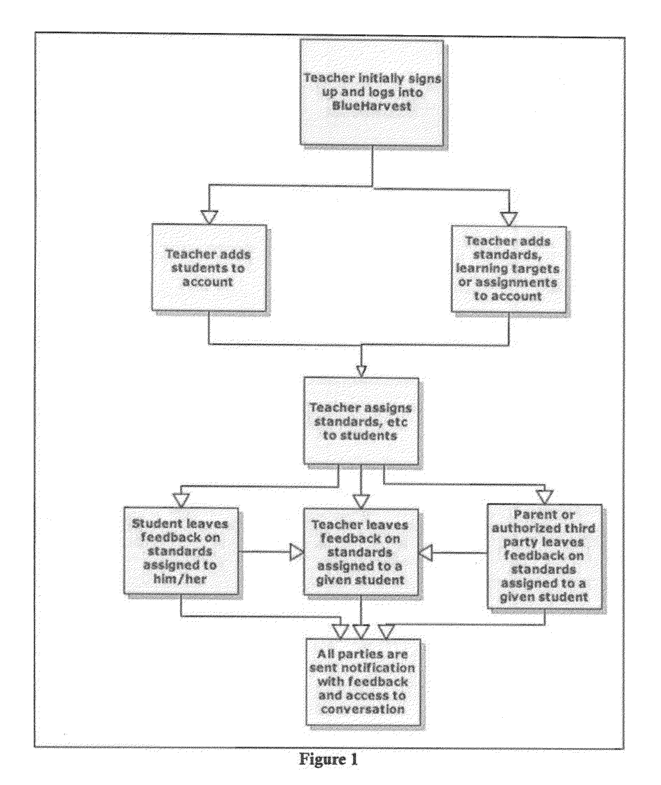

FIG. 1: This figure is a diagram of the logical flow of a user's experience in the system. The system is set up around teachers as the main authorized users and the feedback provided by teachers, students and authorized third parties. This allows a conversation between all interested parties concerning the standards, etc. assigned to the students.

FIG. 2: This figure is an example of what a teacher would see on the main feedback page. It includes a conversation window for each standard, learning target or assignment assigned to the student the teacher is currently viewing. It also includes a control panel where the teacher can select different students or standards and navigate to other parts of the site.

FIG. 3: This figure is an example of what a student, parent or authorized third-party would see on the main feedback page. It includes many of the same features that the teacher has access to in the conversation windows, but has limited functionality in the control panel.

FIG. 4: This figure shows a detailed look at a given conversation window on the main feedback page. Teachers, students and authorized third-parties can leave feedback in a conversation window. They can also include rich media (e.g. uploaded files, webcam pictures, hyperlinks, etc.) into a conversation.

FIG. 5: This figure is an example of an email notification sent to a user who has opted to receive email notifications after feedback has been posted. It includes the feedback that was posted and a link allowing instant access to the main feedback page.

FIG. 6: This figure is an example of the page where standards, learning targets or assignments are assigned to students by a teacher. It is setup such that each student can be assigned an individualized curriculum.

It will be further appreciated that functions or structures of a plurality of components or steps may be combined into a single component or step, or the functions or structures of one-step or component may be split among plural steps or components. The present invention contemplates all of these combinations. Unless stated otherwise, dimensions and geometries of the various structures depicted herein are not intended to be restrictive of the invention, and other dimensions or geometries are possible. Plural structural components or steps can be provided by a single integrated structure or step. Alternatively, a single integrated structure or step might be divided into separate plural components or steps. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention. The present invention also encompasses intermediate and end products resulting from the practice of the methods herein. The use of “comprising” or “including” also contemplates embodiments that “consist essentially of” or “consist of” the recited feature.

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes.

What is claimed is:

1. A method, comprising:
a. receiving conversation data about a topic inputted by a first authorized user;
b. transmitting the received conversation data to a second authorized user for display, and
wherein the first and second authorized users comprise at least one teacher and at least one student,
wherein the conversation data comprises rich media, and
wherein the topic comprises an educational target or attainment of an educational target.

2. The method of claim 1 further comprising a subsequent step of receiving additional conversation data about the topic inputted by the second authorized user.

3. The method of claim 2 further comprising associating the conversation data and additional conversation together to permit later display of the data on the topic by the first or second authorized user.

4. The method of claim 1 wherein authorized users further comprise administrators and parents.

5. The method of claim 1 wherein the authorized users are partitioned according to status.

6. The method of claim 5 wherein the topic further comprises common interests of the partitioned authorized users.

7. The method of claim 1 wherein conversation data further comprises notifications.

8. A method, comprising:
a. receiving from a central server conversation data about a topic inputted by a first authorized user,
b. transmitting additional conversation data about the topic inputted by a second authorized user,
wherein the first and second authorized users comprise at least one teacher and at least one student,
wherein the conversation data comprises rich media, and
wherein the topic comprises an educational target or attainment of an educational target.

9. The method of claim 8 further comprising an initial step of transmitting conversation data about the topic from the second authorized user to the central server.

10. The method of claim 8 wherein authorized users further comprise administrators and parents.

11. The method of claim 8 wherein the authorized users are partitioned according to status.

12. The method of claim 11 wherein the topic further comprises common interests of the partitioned authorized users.

13. The method of claim 8 wherein conversation data further comprises notifications.

14. A system, comprising: one or more processors; memory; and one or more programs, wherein the one or more programs are stored in the memory and configured to be executed by the one or more processors, the one or more programs including:
a. instructions for receiving conversation data about a topic inputted by a first authorized user;
b. instructions for transmitting inputted conversation data about the topic to a display of a second authorized user,
wherein the first and second authorized users comprise at least one teacher and at least one student,
wherein the conversation data comprises rich media, and
wherein the topic comprises an educational target or attainment of an educational target.

15. The system of claim 14 wherein authorized users further comprise administrators and parents.

16. The system of claim 14 wherein the one or more programs further comprise instructions for associating the conversation data inputted by the first authorized user and the conversation data inputted by the second authorized user together to permit later display of the data on the topic by the first or second authorized user.

17. The system of claim 16 wherein instructions for receiving and transmitting and the instructions for associating are executable on different processors.

18. The system of claim 17 wherein the one or more programs further comprises instructions for notifying authorized user regarding the existence of additional conversation data.
